(19) United States
(12) Patent Application Publication
(10) Pub. No.: US 2002/0011911 A1
(43) Pub. Date: Jan. 31, 2002

(54) Choke coil

(76) Inventors: Naoto Kimura, Tokyo-To (JP); Asao Ishikawa, Tokyo-To (JP)

Correspondence Address: JACOBSON, PRICE, HOLMAN & STERN, PROFESSIONAL LIMITED LIABILITY COMPANY, 400 Seventh Street N.W., Washington, DC, 20004, US

(21) Appl. No.: 09/916,681

(22) Filed: Jul. 30, 2001

(30) Foreign Application Priority Data
Jul. 28, 2000 (JP) 2000-228873

(51) Int. Cl. H01F 38/20

(52) U.S. Cl. 336/174

(57) ABSTRACT

A high-frequency choke coil achieves the same low loss across a wide band as a choke coil comprising an external resistor, without using an external resistor. The choke coil comprises a wire-like conductor, wound around a rod-like core; a plurality of individual rod-like cores are joined parallel to their axes with insulators therebetween, forming a rod-like core having a predetermined length; one of the individual rod-like cores has at least (i) a specific dielectric constant at 1 MHz which is more than five times that of the other individual rod-like cores, and/or (ii) a volume resistivity which is less than one-hundredth of that of the other individual rod-like cores.

### BACKGROUND OF THE INVENTION

1. Field of the Invention

The present invention relates to a high-frequency choke coil used in a transmission circuit of a CATV and a community TV system, and more particularly relates to the choke coil which passes a power current and prevents high-frequency signals.

2. Description of the Related Art

In designing this type of choke coil, there must be a good balance between inductance for preventing high-frequency signals, and loss characteristics which affect the transmission characteristics of a high-frequency circuit. A choke coil conventionally comprises a conductor which is wound around a rod-like core. The core reinforces the inductance of the choke coil, and extends the lower limit of the frequency band being used. In order to reduce eddy current loss, the core comprises an NiZn-type ferrite material having a large volume resistivity.

However, in this choke coil, self-resonance is likely to result from capacitance between the coil wires and inductance in the frequency band being used. This increases the loss characteristics of the choke coil at the resonant point, as shown by the solid line in FIG. 5.

The self-resonance of the choke coil is reduced by providing an external fixed resistor R to the lead wire of the choke coil and the intermediate tap, as shown in FIG. 6. As shown by the partially dotted line in FIG. 5, when the fixed resistor is provided, although there is some overall loss, dips at specific frequencies are prevented and an even line is maintained.

On the other hand, an excessively low resistance increases the insertion loss of high-frequency circuits. Therefore, it must be possible to select a resistance which is appropriate to the equipment.

Choke coils tend to become larger as the power current to be passed through them increases. Until a few years ago, choke coils operated at approximately 8A at an alternating current of 60 Hz, but recently there is a need for 12 to 15 A. In view of this, the coil is made larger by increasing the diameter of the coil wire to carry a larger current through the choke coil, increasing the number of coil windings for maintaining the necessary inductance, and so on.

Nevertheless, attaching the fixed resistor to the intermediate tap of the coil tends to increase the parasitic capacitance of the coil. As a result, when the choke coil is incorporated in a device, unwanted capacitive high-frequency coupling occurs between the choke coil and the device case and the circuit board, increasing the self-resonance of the choke coil and the high-frequency loss of the circuit.

Accordingly, there is a need for a choke coil having a simple constitution which does not require an external fixed resistor and an intermediate tap to reduce high-frequency loss, and which has low loss over a wide band even when the current is increased.

### SUMMARY OF THE INVENTION

The present invention has been achieved in order to solve the above problems. It is an object to provide a high-frequency choke coil having low loss over a wide band without using an external resistance.

In order to achieve the above objects, this invention provides a choke coil comprising a wire-like conductor wound around a rod-like core. The rod-like core has a predetermined length, and comprises a plurality of individual rod-like cores which are joined parallel to their axes with insulators provided therebetween. One of the individual rod-like cores has at least (i) a specific dielectric constant at 1 MHz which is more than five times that of the other individual rod-like cores, and/or (ii) a volume resistivity which is less than one-hundredth of that of the other individual rod-like cores.

### BRIEF DESCRIPTION OF THE DRAWINGS

FIG. 1 is a diagram showing the constitution of an embodiment of this invention;

FIGS. 2A and 2B are diagrams showing examples of circuit constitutions of two transmitting apparatuses comprising the choke coil shown in FIG. 1;

FIG. 3 is a characteristics diagram showing frequency—loss measurements of the embodiment of FIG. 1;

FIG. 4 is a circuit diagram showing the connected state when the measurements of FIG. 3 were obtained;

FIG. 5 is a characteristics diagram showing measurements of insertion loss characteristics of a conventional high-frequency choke coil; and

FIG. 6 is a diagram showing the circuit constitution used in the measuring of FIG. 5.

### DESCRIPTION OF THE PREFERRED EMBODIMENT

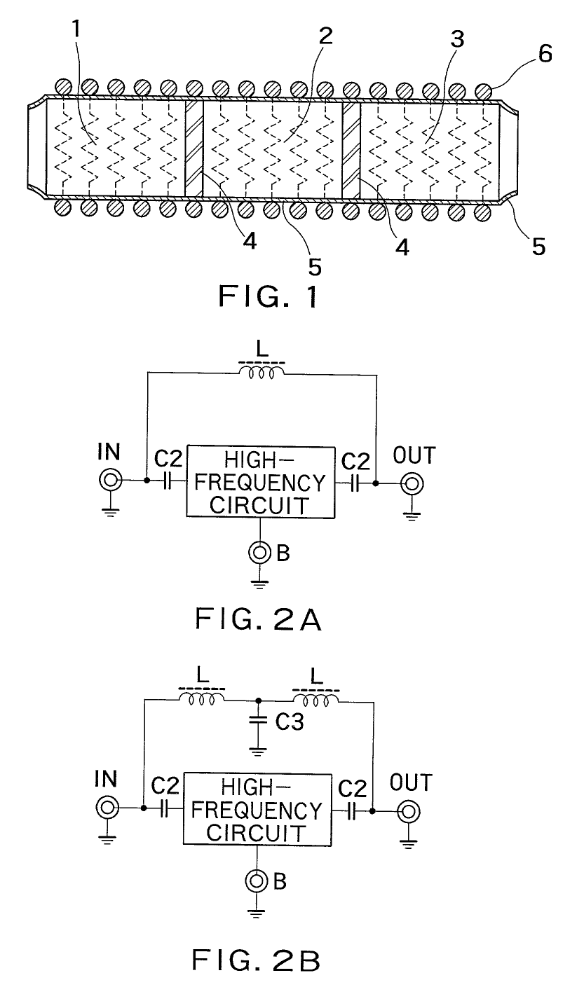

FIG. 1 is a vertical cross-sectional view of an embodiment of this invention. In the embodiment of FIG. 1, three individual rod-like cores 1, 2, and 3 are joined together parallel to their axes, thereby forming one rod-like core. The individual rod-like cores 1, 2, and 3 are substantially round-ended columns. Insulators 4 are inserted between the individual rod-like cores, and a thermally compressive resin tube 5 secures them together to comprise the rod-like core.

The individual rod-like cores 1 and 3 each comprise a rod-like MnZn ferrite core having a diameter of 4 mm, a length of 7 mm, an initial relative dielectric constant of 200, a relative dielectric constant of 8000 at 1 MHz, and a material constant volume resistivity of 5 Ω·m. The other individual rod-like core 2 comprises a rod-like NiZn ferrite core having a diameter of 4 mm, a length of 10 mm, an initial relative dielectric constant of 330, a relative dielectric constant of 14 at 1 MHz, and a material constant of volume resistivity 10 kΩ·m. The insulators 4 are inserted between the cores 1, 2, and 3, and comprise a resin material having a thickness of 1 mm and a relative dielectric constant of approximately 3 to 4. The thermally compressive resin tube 5 covers and secures the cores 1, 2, and 3, with the insulators 4 inserted therebetween, thereby forming the rod-like core.

A coil 6 is wound around the outside of the rod-like core. The coil 6 comprises a polyester-covered copper wire having a diameter of 1.3 mm, and is wound approximately twenty turns around the outside of the rod-like core. This obtains a choke coil having a core of approximately 2 μH.

In the choke coil described above, a high-frequency resistance is created by the electrical constants of the cores 1 and 3, and acts an a dump resistance against the self-resonance of the choke coil caused by inductance and inter-wire capacitance. The core 2 also has a small degree of high-frequency resistance, but does not have as great an effect as the cores 1 and 3.

There is mild magnetic coupling between the individual rod-like cores 1, 2, and 3 which comprise the rod-like core, via the insulators 4. Therefore, a desired inductance can be obtained with low insertion loss at high frequencies.

FIGS. 2A and B show examples of circuit constitutions on two transmitting apparatuses comprising the choke coil shown in FIG. 1. In each case, the apparatus comprises a directional coupler for multiplexing a power current.

In FIG. 2A, a high-frequency circuit is provided via capacitors C1 and C2 between an input terminal IN and an output terminal OUT, and a branch signal from the high-frequency circuit is extracted to a branch terminal B. The input terminal IN and the output terminal OUT are directly connected together by a choke coil L, and a power current is passed therethrough.

In FIG. 2B, two choke coils are connected in series and directly connect the input terminal IN to the output terminal OUT. The point of connection between the two choke coils is grounded by a capacitor C3.

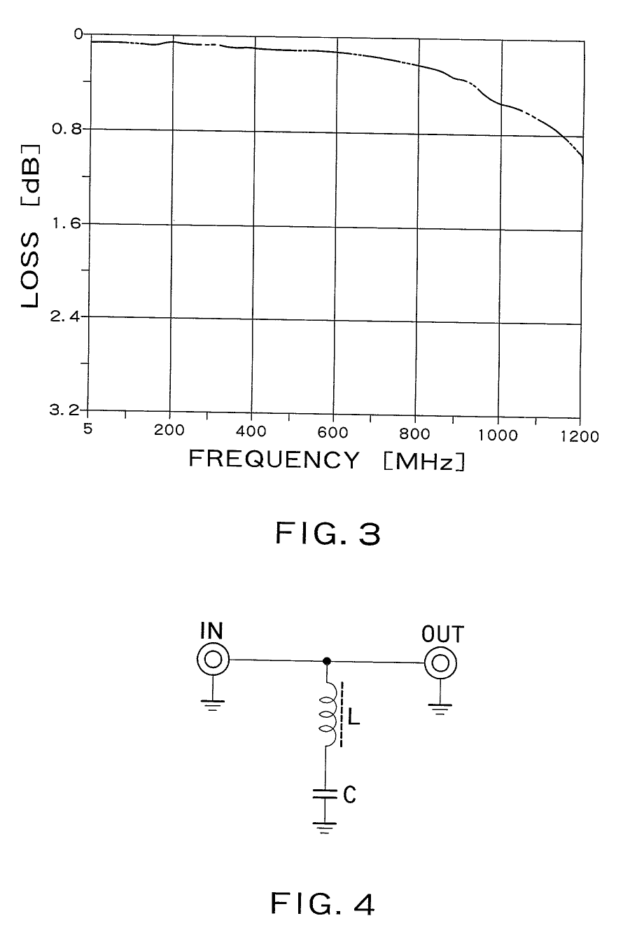

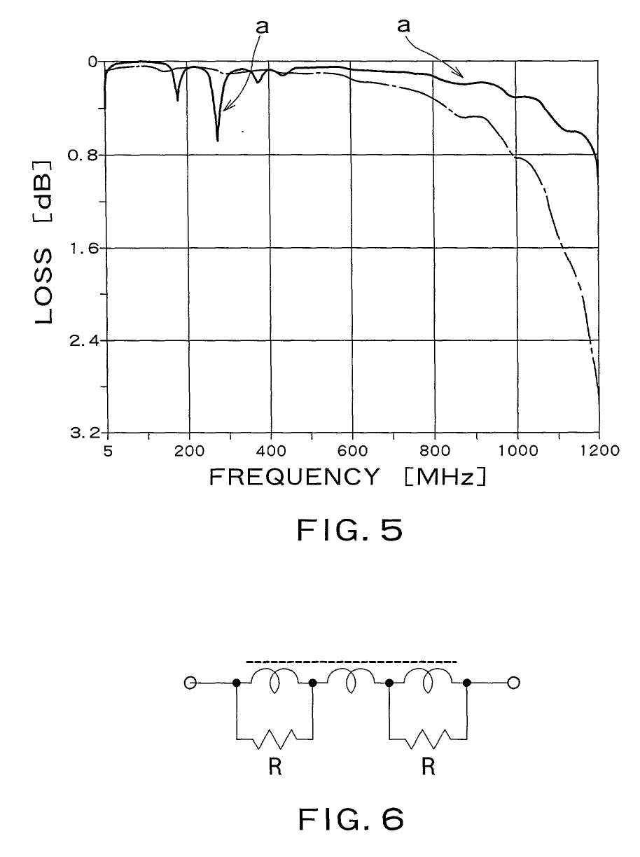

FIG. 3 shows measurements of frequency—loss characteristics of the embodiment shown in FIG. 1. As shown in FIG. 3, the characteristic curve is substantially flat at approximately 0.1 dB until 500 to 600 MHz, and gradually decreases thereafter, showing a loss of 0.2 dB at 800 MHz, 0.5 dB at 1000 MHz, and 1.0 dB at 1200 MHz.

FIG. 4 shows the connected state when the measurements of FIG. 3 were obtained. The input terminal IN and the output terminal OUT are joined by a connecting wire, and are grounded midway by a series circuit comprising the choke coil L and the capacitor C.

### Other Embodiments

In the embodiment described above, one of the individual rod-like cores which comprise a rod-like core having a predetermined length need only have at least (i) a specific dielectric constant at 1 MHz which is more than five times that of the other individual rod-like cores, and/or (ii) a volume resistivity which is less than one-hundredth of that of the other individual rod-like cores.

Preferably, at least one of the individual rod-like cores should have an initial specific permeability of more than 2000, and the other individual rod-like cores should have an initial specific permeability of less than 2000.

More preferably, at least one of the individual rod-like cores should have a specific dielectric constant at 1 MHz of more than 100, and the other individual rod-like cores should have a specific dielectric constant of less than 20.

Preferably, at least one of the individual rod-like cores should have a volume resistivity of less than 10 Ω·m, and the other individual rod-like cores should have a volume resistivity of more than 1 KΩ·m.

The embodiment described above uses three individual rod-like cores. A long low-loss core is provided in the center, and cores comprising distributed constant high-frequency resistors are provided on either side of the center core with insulators therebetween, thereby forming the rod-like core. Alternatively, more than three individual rod-like cores may be used, and the arrangement of the individual rod-like cores may be changed.

As described above, a rod-like core having a predetermined length is made by combining a plurality of several types of individual rod-like cores having appropriate specific dielectric constants and volume resistivities. A coil is wound around the rod-like core, thereby comprising a choke coil. This makes it possible to provide a distributed constant choke coil having high-frequency resistance which does not require an external resistor.

What is claimed is:

1. A choke coil comprising a wire-like conductor wound around a rod-like core,
said rod-like core comprising a plurality of individual rod-like cores which are joined parallel to their axes with insulators provided therebetween, thereby comprising the rod-like core having a predetermined length; and
one of said individual rod-like cores having at least (i) a specific dielectric constant at 1 MHz which is more than five times that of the other individual rod-like cores, and/or (ii) a volume resistivity which is less than one-hundredth of that of said other individual rod-like cores.

2. The choke coil as described in claim 1, wherein at least one of said individual rod-like cores has an initial specific permeability of more than 2000, and the other individual rod-like cores have an initial specific permeability of less than 2000.

3. The choke coil as described in claim 1, wherein at least one of said individual rod-like cores has a specific dielectric constant at 1 MHz of more than 100, and the other individual rod-like cores have a specific dielectric constant of less than 20.

4. The choke coil as described in claim 1, wherein at least one of said individual rod-like cores has a volume resistivity of less than 10 Ω·m, and the other individual rod-like cores have a volume resistivity of more than 1 KΩ·m.
